(19) United States
(12) Patent Application Publication
(10) Pub. No.: US 2024/0255043 A1
(43) Pub. Date: Aug. 1, 2024

(54) PLANETARY GEAR REDUCER WITH AT LEAST ONE PLANET GEAR WITH AT LEAST ONE EXTERNAL THREAD PORTION

(71) Applicant: DIAKONT S.R.L., Montespertoli (FI) (IT)

(72) Inventors: Mikhail Evgenievich FEDOSOVSKIY, Saint Petersburg (RU); Romain Vladimirovich GODUNOV, Saint Petersburg (RU)

(21) Appl. No.: 18/564,487

(22) PCT Filed: May 25, 2022
(86) PCT No.: PCT/RU2022/050166

§ 371 Date: Nov. 27, 2023

(30) Foreign Application Priority Data
May 25, 2021 (RU) 2021114862

(51) Int. Cl. F16H 1/28; F16H 57/08

(52) U.S. Cl. CPC F16H 1/28; F16H 57/082; F16H 2001/289; F16H 2057/085

(57) ABSTRACT

The present invention relates to torque variation planetary gears. According to the present invention, a gear reducer is provided, which comprises: a housing comprising at least one internal thread portion; at least one pinion arranged in the housing, the at least one pinion being fixed from axial movement relative to the housing and comprising at least one external thread portion engaged with the at least one internal thread portion of the housing, wherein elevation angles of the external thread portion and the internal thread portion are equal and directions thereof are aligned. The gear reducer further comprises a sun gear arranged in the housing and configured to drive the at least one pinion, and a carrier arranged in the housing and configured to rotate relative to the housing, wherein the at least one pinion is rotatably connected to the carrier in a bearing support mounted in the carrier. The achieved technical effect is an increase in resistance of the gear reducer to impact loads and overloads by torque applied to output link.

### FIELD OF THE INVENTION

The present invention relates to torque variation planetary gears and, in particular, to a planetary gear reducer with externally threaded roller pinions.

### BACKGROUND OF THE INVENTION

Use of planetary gear reducers for rotating joints of industrial manipulators (hereinafter referred to as manipulators) is known in the art. One link of the manipulator is attached to the output link of the planetary gear reducer, and the second link of the manipulator is attached to the gear reducer housing. When the input link of the planetary gear reducer is rotated by, for example, an electric motor with the shaft thereof connected to the input link of the gear reducer and the housing thereof secured to the second link of the manipulator, the output link rotates relative to the housing of the planetary gear reducer. The output link rotational speed and the torque at the output link differ from the input link rotational speed and the torque at the input link of the planetary gear reducer. Thus, the movement of manipulator links relative to each other is achieved. The manipulator can comprise a number of links and, accordingly, a number of joints for moving the links relative to each other. Manipulators are used for automating technological processes, such as moving car body panels during assembly or moving goods during sorting and packaging. The above and similar applications imply 24-hour cyclic operation. Cyclic operation implies a change in the rotational direction of gear reducers in manipulator joints. Over each movement cycle, the manipulator starts moving multiple times and stops multiple times. To increase performance, the start and the end of movement shall occur with high acceleration which, when paired with the payload on the manipulator, leads to a significant torque overload on each manipulator joint. It shall be noted that during the process of introducing the manipulator into service and setting up its movement software, the manipulator links may collide with other equipment in the production line, which causes impact loads on gear reducers in manipulator joints. With the increase in automation, the amount of technological process automation equipment which can be located in close proximity to the manipulator increases as well. It is important that the gear reducer does not fail in such emergency situations in order to prevent lengthy manipulator recovery.

In order to ensure high production line performance, it is preferable to have an extended maintenance interval for the manipulator, the maintenance procedure including replacing the lubricant lubricating the working surfaces of the gear reducer mechanism.

U.S. Ser. No. 10/352,400B2, publ. Jul. 16, 2019, discloses a planetary gearbox in which the output link is represented by two flanges with openings wherein the bearing supports are arranged. Pinions are mounted into the bearing supports, the toothed rims thereof mating with the toothed rim of the crown gear forming the housing of the gearbox. By rotating about their axis and performing a planetary movement, the pinions drive the output link. In this case, the toothed rims of the pinions can be spur rims, helical rims or herringbone rims.

The teeth used in the gears disclosed in the prior art gearbox generally have an involute lateral surface profile. The torque on the gear forms a circumferential force applied to the lateral side of the tooth at the point of contact and causing bending stresses with a maximum value on the tooth surface at its base which, during long-term operation of the gearbox experiencing impact loads and when the torque is exceeded, leads to the destruction of the tooth and to premature failure of the gearbox. When the pinions are rotated and rolled on the toothed rim of the gearbox housing, that is, when pinions perform planetary movement, the teeth contact spot, which can be represented by a line, moves along the teeth of the pinion and the toothed rim of the gearbox from their base to the top and back to ensure constant contact between at least one pair of teeth, which leads to significant bending stresses in the tooth base when the contact line is in the top part of the tooth. Typically, teeth with a low profile angle (typically 20 degrees) are used, which further increases the stresses in the tooth base due to small thickness of the tooth at the base. The use of the involute profile imposes further limitations on reducing contact stresses at the point of tooth contact due to the fact that the profile cannot be changed while simultaneously ensuring constant contact between at least one pair of gear teeth in order to reduce contact stresses. To reduce bending stresses, helical gears are used instead of spur gears. This allows to distribute the load among a larger number of teeth and increase tooth thickness. However, the type of contact in the helical gear remains linear, with movement from the top to the base and back. Further, helical gears are arranged with a tooth inclination angle relative to the gear axis, leading to a greater load acting on each tooth normally towards its lateral surface. It follows from the above that a significant disadvantage of the prior art gearbox is the reduced resistance to impact loads and torque overloads of the output link of the gearbox. It is important to note that toothed engagement involves each tooth coming out and back into engagement when the gears rotate relative to each other, which increases noise and reduces smoothness of manipulator joint rotation.

When switching from spur gears to helical gears while maintaining the gear ratio of the gear reducer, it is necessary to increase gear diameter to accommodate the initial number of teeth, leading to an increase in size and weight of the gear reducer. If the size of the gear reducer is maintained, the number of teeth on the gear must be reduced, which will result in a change in gear ratio and a change in torque at the output link or the input link. Therefore, it is impossible to increase bending strength of the teeth without increasing the dimensions while maintaining gear ratio of the gear reducer.

To ensure the resistance of the gear reducer to cyclic overloads by torque applied to the output link of the gear reducer when changing movement direction of the manipulator link, it is necessary to increase the resistance of the tooth to cyclic loads with different acting directions. For this purpose, the tooth thickness shall be increased. The increase in tooth thickness leads to an increase in gear module, which in its turn, while maintaining the gear ratio of the gear reducer, requires an increase in the diameter of pinions and the housing as it is impossible to arrange a small number of teeth on the pinion while ensuring resistance of the gear reducer to impact loads and overloads at the output link, as will be discussed below. The size increase further results in a weight increase of the gear reducer, which increases the load on all manipulator joints located closer to the base of the manipulator than the joint wherein the prior art gearbox is mounted.

It shall also be noted that in order to increase torque at the output link of such a gearbox, an increase in gear ratio is required. Increasing gear ratio requires an increase in the difference between the number of teeth on the pinion and on the crown gear. If the size of the gearbox is to be maintained, this requires a reduction in the number of teeth on the pinion. Cutting a small number of teeth on the pinion or any other gear results in undercutting, wherein a part of the tooth profile is cut away, which leads to a decrease in the end overlap and to a gap forming between gear teeth. The gap causes the gears to collide when their teeth come into contact, resulting in vibration. Reducing the overlap leads to an increase in pressure on the tooth contact area as a consequence of reducing resistance of the gearbox to impact loads and overloads, which leads to premature failure. In order to avoid the above disadvantages and maintain the dimensions and weight of the gear reducer, it is possible to reduce the gear module, which leads to a reduction in the tooth size and allows for an increase in the number of teeth on the pinion. However, with a decrease in the tooth size, the thickness of tooth base also decreases, which leads to a decrease in its ability to withstand bending loads arising from impact loads on the output link, which leads to destruction of the teeth and premature failure of the gear reducer. Gear reducer failure causes production line downtime during gear reducer replacement or repair in the manipulator joint. Thus, a significant disadvantage of the prior art gearbox is a limited range of gear ratios.

In the prior art gearbox, the pinion comprises two toothed rims, one of which is engaged with the toothed rim of the crown gear, while the second is engaged with the sun gear. Another defining characteristic of gear reducers with toothed engagement is the fact that, in order for the reducer to be assemblable, the number of pinions must be a multiple of the number of teeth on the crown gear and of the number of teeth on the sun gear, which limits the number of pinions and does not allow for arranging the number of pinions in the reducer that would fit with a gap therebetween for free rotation, thus reducing maximum torque that can be applied to the output link.

To increase the resistance of the planetary gear reducer with toothed engagement to impact loads and overloads by torque, the width of the toothed rims is increased, but at the same time, as the width of the toothed rims increases, the effectiveness of the measure decreases, and upon reaching a certain width, the reverse effect is observed due to uneven load on the tooth along its length due to linear contact and high stiffness of the tooth, which leads to insufficient load on some portions and exceeding permissible stresses on other portions of the tooth along its length, which leads to destruction of the tooth and failure of the gear reducer.

It shall be noted that in the prior art gearbox design, the output link is formed by a carrier which is formed by two flanges spaced apart from each other, allowing to place toothed rims of the pinions therebetween. The flanges are connected to each other to form a rigid structure in order to avoid misalignment of pinion axes under the action of torque applied to the output link. Obviously, in order to establish such a connection, it is necessary to place the elements by means of which the flanges will be connected, for example protrusions on the end surface of one flange adjacent to the end surface of the second flange, between flanges. Further, the flanges can be compressed using fasteners, for example screws. The protrusions occupy the volume between the flanges and the pinions, which are uniformly distributed along the circumference.

The gear reducer is typically partially filled with lubricant, for example oil, which lubricates gear teeth and bearings. The lubricant is mixed and circulated over the internal volume of the gear reducer when the pinions are rotated relative to the carrier and when the carrier is rotated relative to the housing, when the input link is rotated, the input link formed in the prior art gearbox by the sun gear. In the areas between protrusions, the flow of lubricant in the bearing area wherein pinions are mounted is reduced, which is caused by a small angle of teeth inclination relative to the pinion axis in the case of using helical or herringbone toothed rims on pinions. In the case of using spur toothed rims, the lubricant flow is virtually absent. This characteristic causes an increase in lubricant heating in contact areas of the teeth and in the bearings, which leads to lubricant degradation, increased wear under the influence of impact loads and overloads by torque at the output link of the gearbox, and failure thereof.

Further, the patent document RU2719091C1, publ. Apr. 17, 2020 discloses a roller screw gear reducer (hereinafter referred to as RSG) which is a type of planetary gear reducers. The input link of the reducer is formed by a screw with two portions of external thread threaded in opposite directions. Multiple rollers are arranged around the screw, the rollers similarly having two portions of external thread threaded in opposite directions. Threads of said screw portions contact the corresponding portions of the external thread of said multiple rollers. One of the thread portions on the rollers and a part of the second thread portion on the rollers contact two portions of the internal thread of the first power link forming the output link of the RSG. A part of the second thread portion on the rollers contacts the internal thread of the second power link acting as the RSG housing. When the input link rotates, the rollers perform a planetary movement around the screw, rolling along the portion of the external screw thread and the portions of the internal thread of the RSG power links. Due to the difference in the number of internal threads starts in the first and the second power links, torque is formed therebetween, as well as a change in torque and rotation speed of the output link of the gear reducer relative to the RSG input link.

To ensure assemblability, the number of rollers in the prior art gear reducer must be a multiple of the difference between the number of internal threads starts of the first and the second power links, which precludes the possibility of increasing the torque applicable to the output link of the gear reducer without changing gear ratio.

In such a reducer, the thread has a certain elevation angle relative to the longitudinal axis of its elements, and further has a profile shape implying contact between two threads along surfaces inclined relative to the longitudinal axis of the parts, which leads to the occurrence of radial and axial force when applying torque to the rollers, the screw and the power links. The structure lacks any structural elements, for example a carrier, preventing radial movement of the rollers towards the screw. It follows from the above that when torque is applied to the first power link, the rollers are pressed against the RSG screw, making it necessary to apply increased torque to the input link and, as a result, increasing losses and reducing efficiency of the RSG. It is important to note that the force with which the rollers are pressed against the screw increases proportionally with the increase in torque applied to the output link. Further, the greater the RSG gear ratio, the less torque needs to be applied to the input link at a constant torque at the output link. This results in an increase in the proportion of torque at the input link spent on counteracting the torque arising from the rollers being pressed against the screw. Increased torque at the output link leads to increased heating of the electric motor, which can be affixed on the RSG housing and used to drive the RSG screw, which also increases heating of the RSG and of the lubricant therein, thus increasing its degradation. The absence of structural elements, for example a carrier preventing radial movement of the rollers towards the screw in the prior art RSG leads to the occurrence wherein, as the threads are getting worn, the roller radially shifts and changes the diameter of the threads on which the rollers roll along the internal threads of the power links and the screw. The change in said diameters leads to a change in the gear reducer gear ratio due to a change in the number of roller revolutions per screw revolution.

It shall be noted that in the prior art RSG, the roller has a portion of the thread with a constant thread elevation angle along the length of the portion. Said thread portion simultaneously contacts the first and the second power links having different numbers of thread starts as discussed above and therefore, a different elevation angle when the diameter remains constant. The difference in the elevation angle leads to the occurrence wherein the contact spot of the roller threads and one of the power links is not arranged on the straight line passing through the axes of the roller and the power link in the plane perpendicular to the reducer axis, which leads to generation of additional torque acting on roller. The additional torque causes slippage and therefore, additional sliding friction in the contact between roller and one of the power links, the elevation angle thereof not coinciding with that of the roller thread. This leads to additional heating and wear when subjected to impact loads and overloads by torque at the output link.

Thus, a significant disadvantage of the prior art RSG is reduced efficiency depending on the RSG gear ratio and on the torque at the output link. This disadvantage leads to an increase in the load on reducer threads at a constant torque at the output link. Consequently, the wear of the threads increases, the gaps between threads widen leading to vibration and noise, and the RSG and the electric motor are further heated when subjected to impact loads and overloads by torque arising at the output link of the reducer when manipulator links move in dynamic operation, causing premature failure and production line downtime.

Thus, the object of the present invention is to develop a gear reducer with increased resistance to impact loads and overload by torque while maintaining the dimensions of its constituent elements and increasing efficiency.

### SUMMARY OF THE INVENTION

According to the present invention, there is provided a gear reducer comprising: a housing comprising at least one internal thread portion or non-rotatably connected to a part comprising at least one internal thread portion; at least one pinion arranged in the housing, the at least one pinion being fixed from axial movement relative to the housing and comprising at least one external thread portion engaged with the at least one internal thread portion of the housing, wherein an axis of rotation of the at least one pinion is offset from an axis of rotation of the housing, wherein elevation angles of the external thread portion and the internal thread portion are equal and directions thereof are aligned. The gear reducer further comprises a sun gear arranged in the housing and configured to drive the at least one pinion, wherein an axis of rotation of the sun gear is aligned with the axis of rotation of the housing, and a carrier arranged in the housing and configured to rotate relative to the housing, wherein the at least one pinion is rotatably connected to the carrier in a bearing support mounted in the carrier, wherein the axis of rotation of the carrier is aligned with the axis of rotation of the housing.

The achieved technical results include an increase in resistance of the gear reducer to impact loads and overloads by torque applied to the output link, an increase in gear ratio range, increased smoothness in operation, increased gear ratio accuracy, a reduction in gear ratio change over the service life, increased efficiency and prolonged maintenance interval while maintaining overall dimensions and weight.

Further disclosed is a joint comprising the gear reducer according to one of the embodiments, as well as a first joint portion secured on the gear reducer housing and prevented from relative movement, and a second joint portion secured on the gear reducer carrier and prevented from relative movement.

Thus, due to the combination of essential features, a gear reducer was developed, which has increased resistance to impact loads and overloads by torque applied to its output link while maintaining the dimensions of the components and increasing efficiency.

Due to the fact that the structure comprises one or more pinions driving the output link which takes on the largest amount of torque in the reducer and engaged with the housing by means of threads, a smaller number of threads starts can be made on the pinions compared to the gearing. Thus, the range of possible gear ratios of the reducer is increased while maintaining torque value and the value of the possible overload by torque at the output link, since this does not require a reduction in contact area of the parts and the turn size.

An important advantage of the disclosed threaded engagement is the lack of movement in the contact between the pinion threads and the housing, which can be represented by a point, from the base to the top of the thread turn during planetary movement of the pinions, which eliminates significant bending stresses in the base of the turn. It should be noted that such contact behavior prevents the thread turn from coming in and out of engagement when pinions roll over the reducer housing. Lack of spot (point) movement eliminates the need for a special thread profile to ensure continuous contact, thus allowing for optimal curvature of the contacting pinion surfaces and the housing depending on the gear ratio and the size of the thread turn, and further allows to increase the profile angle in order to achieve a reduction in contact stresses and bending stresses. Another important advantage of the lack of spot movement from the base to the top of the thread turn is the possibility of implementing a thread having the height and the profile angle allowing to reduce the number of turns on a pinion and, thus, increase the gear ratio of the gear reducer. It should also be noted that the use of threaded engagement allows to utilize a number of pinions in the gear reducer depending on the torque applied to the output link, wherein the maximum number of pinions is limited only by the presence of a gap between the pinions ensuring free rotation thereof, which allows for a significant increase in maximum torque that can be applied to the output link, and therefore, an increase in resistance of the gear reducer to impact loads and overloads by torque.

Due to the presence of the carrier precluding radial movement of the pinions towards the sun gear and taking on the radial load acting on each pinion when the torque is applied to the output link, there is no additional load of the sun gear, and therefore, friction losses in the engagement are reduced and the efficiency of the gear reducer is increased. The disclosed carrier further allows to maintain inter-axial pinion distance over the course of thread wear during service life, and therefore to maintain the location of the contact spot of pinion threads and the reducer housing at constant distances from pinion and housing axes which are correlated similarly to the correlation between the number of pinion threads and reducer housing threads starts, and to further reduce the changes in gear ratio of the gear reducer.

Due to the presence of bearings mounted in the carrier wherein the pinion is mounted, the pinion is prevented from axial movement, thus allowing to achieve a gear ratio of the gear reducer that is close to that determined by the ratio of the number of pinion and housing threads starts, taking into account manufacturing tolerances depending on the selected threading method and equipment accuracy.

The threads between the pinions and the housing ensure the flow of lubricant therebetween. Further, the contact of the thread portions of the pinions with the housing having the same elevation angle ensures that the contact spot of the thread portions is on a straight line passing through the axes of the pinion and the housing in a section perpendicular to the gear reducer axis. This allows to reduce sliding friction for contacting surfaces and to reduce their wear under impact loads and overloads by torque applied to the output link of the gear reducer. Further, heating of the surfaces (and therefore, the lubricant) is reduced, thus reducing lubricant degradation. The reduction in lubricant degradation leads to an increased maintenance interval, which leads to an increase in production line efficiency.

At the same time, due to the use of pinions driving the output link with external thread portions instead of teeth, an increase in smoothness of the gear reducer operation was achieved causing reduction in noise during operation, as well as reduction in wear of the working surfaces of the pinions and the housing due to a lack of toothed engagement, as discussed above in the context of the prior art solutions.

In one embodiment, the housing or the part non-rotatably connected thereto comprises two internal thread portions, thread directions of the portions being opposite, and the pinion comprises two external thread portions, thread directions of the portions being opposite. The two thread portions with opposite directions allow to balance axial forces arising when the torque is applied to the output link of the gear reducer and acting between the pinion and the housing, to prevent axial movement of the pinion, to eliminate the need for structural elements aimed at taking on said axial loads, to prevent axial movement of the pinion and thus to simplify the design of the gear reducer.

In one embodiment, the bearing support is configured to bear an axial load to prevent axial movement of the pinion.

In one embodiment, the sun gear comprises at least one external thread portion allowing the sun gear to engage a thread portion of the at least one pinion, wherein elevation angles of said threads are equal and directions of said threads are opposite, allowing to reduce the number of gear reducer parts and reduce its length and weight.

In one embodiment, the gear reducer comprises at least one gear, wherein the sun gear is engaged with the at least one gear fixedly connected to the at least one pinion, which allows to increase the range of gear ratios of the gear reducer due to the presence of an extra gear in the gear reducer while maintaining the resistance of the gear reducer to impact loads and overloads by torque by maintaining the dimensions of the pinion, the pinion threads and the gear reducer housing.

In one embodiment, the pinion with the two external thread portions is fixedly connected to the at least one gear using a spline connection. In this embodiment, due to the presence of a plurality of splines taking on the torque, the resistance of the gear reducer to impact loads and overloads by torque at the output link is increased.

In one embodiment, the gear reducer comprises an electric motor with a gear on the electric motor shaft, and the sun gear comprises a toothed rim engaged with the gear, wherein an electric motor axis is offset from a housing axis, which allows to increase the gear ratio of the gear reducer due to the presence of an extra gear in the gear reducer while maintaining the resistance of the gear reducer to impact loads and overloads by torque by maintaining the dimensions of the pinion, the pinion threads and the gear reducer housing, and to provide access to the axial opening provided according to another embodiment at the two ends thereof.

In one embodiment, the gear reducer comprises an electric motor with a gear on the electric motor shaft, the electric motor arranged so that the gear of the electric motor is engaged with a toothed rim on the sun gear with which the at least one gear is engaged. Improved manufacturability is therefore achieved by reducing the number of treated surfaces.

In one embodiment, the housing is comprised of two parts arranged coaxially in series and prevented from relative movement, each part comprising one internal thread portion, wherein a thread direction of each portion is opposite, and/or the at least one pinion is comprised of two parts arranged coaxially in series and prevented from relative movement, each part comprising one external thread portion, wherein thread direction of each portion is opposite. In this embodiment, the length of the gear reducer is reduced by eliminating the need for a cylindrical portion between two thread portions to provide free space for removing the thread-cutting tool in order to avoid cutting the threads of one portion when threading the other portion.

In one embodiment, the sun gear comprises at least two external thread portions of opposite directions engaged with the at least one pinion, and the housing is comprised of two parts arranged coaxially in series and prevented from relative movement, each part comprising one internal thread portion, wherein a thread direction of each portion is opposite, and/or the at least one pinion is comprised of two parts arranged coaxially in series and prevented from relative movement, each part comprising one external thread portion, wherein a thread direction of each portion is opposite, and/or the sun gear is comprised of two parts arranged coaxially in series and prevented from relative movement, each part comprising one external thread portion, wherein a thread direction of each portion is opposite. In this embodiment, similarly to the embodiment previously described, the length of the gear reducer is reduced by eliminating the need for a cylindrical portion between two thread portions to provide free space for removing the thread-cutting tool in order to avoid cutting the threads of one portion when threading the other portion.

In one embodiment, the sun gear is mounted on a shaft with an axial opening. For example, cables for electric motors driving subsequent manipulator links after the link wherein the gear reducer is installed can be passed through the opening.

In one embodiment, the sun gear is mounted on a hollow shaft enclosing a hollow cylinder fixedly connected to the gear reducer housing directly or by means of a flange. The above features of the embodiment allow to simplify the design of the manipulator joint assembly by providing a fixed cylinder with an opening through which, for example, cables for electric motors driving subsequent manipulator links after the link wherein the gear reducer is installed can be passed.

In one embodiment, the sun gear and the at least one gear comprise thread portions engaged with each other. The threaded engagement of the gear and the sun gear increases resistance of the gear reducer to impact loads and overloads by torque at the output link, increases the range of gear ratios, and further allows use of any number of pinions fitting with the gear reducer provided that there is a gap therebetween for providing free rotation, which additionally increases resistance of the gear reducer to impact loads and overloads by torque at the output link.

In one embodiment, the gears comprise two thread portions of opposite directions and the sun gear comprises two thread portions of opposite directions, wherein the engaged portions have equal elevation angles and opposite thread directions, thereby balancing axial forces produced when torque is applied to the output link of the gear reducer, thus reducing the load on pinion threads in the embodiment with two thread portions on the pinion and the housing, and reducing the load on the bearings wherein the pinion is mounted, in the embodiment with one thread portion on the pinion and the housing.

### BRIEF DESCRIPTION OF THE DRAWINGS

The invention is explained in more detail in the context of non-limiting embodiments with reference to the accompanying drawings, wherein:

FIG. 1 is a longitudinal section of a planetary gear reducer, wherein each pinion and the housing have two thread portions of opposite directions, each pinion is configured to be driven by a gear fixedly connected thereto and engaged with a sun gear.

FIG. 2 is a longitudinal section of a planetary gear reducer, wherein the pinion and the housing have two thread portions of opposite directions, the pinion is configured to be driven by a sun gear comprising two thread portions of opposite directions.

FIG. 3 is a longitudinal section of a joint comprising the planetary gear reducer, with the first and the second parts of the joint attached to the housing and the flange of the gear reducer.

### DETAILED DESCRIPTION OF THE INVENTION

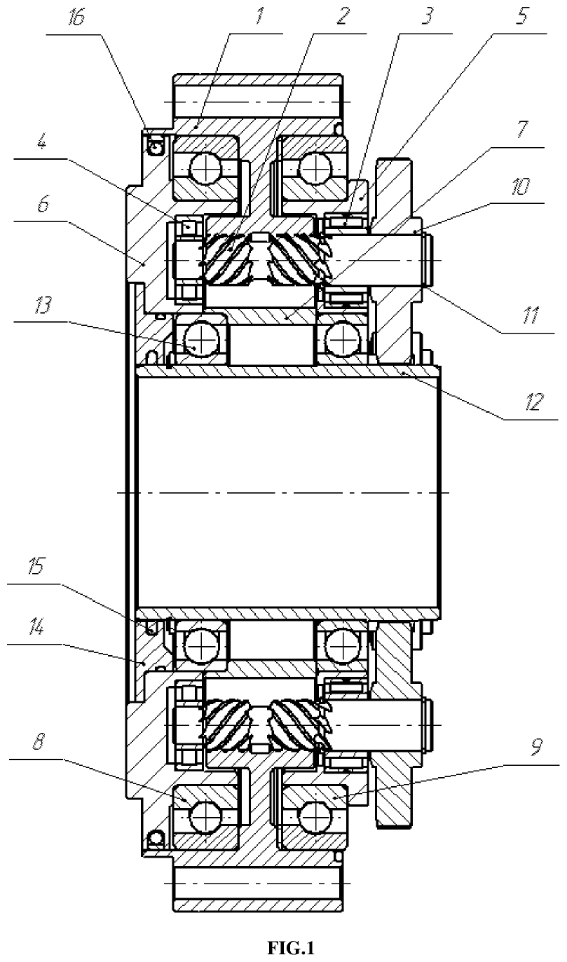

The planetary gear reducer according to one preferred embodiment comprises a housing 1 (FIG. 1) with an axial opening, with two internal thread portions arranged on an inner surface of the gear reducer, while directions of the threads are opposite. In the disclosed embodiment, the housing 1 is affixed to a mechanism, for example to one of manipulator links which is to be moved relative to another manipulator link. For this purpose, the housing 1 is provided with openings arranged closer to its outer diameter through which fasteners, for example screws (not shown in the figure), can be passed. A plurality of pinions 2 are uniformly distributed around the circumference within the housing 1. A number of the pinions 2 depends on the available space taking into account a gap therebetween for free rotation and on the amount of torque applied to an output link of the gear reducer. Therefore, an embodiment can be contemplated, in which there can be one pinion 2 arranged within the housing 1. The pinion 2 comprises two external thread portions, while directions of the threads are opposite. The thread portions of the housing 1 contact the thread portions of the pinions 2. An elevation angle and the direction of the threads of the housing 1 and the pinions 2 are identical but the number of threads starts on the parts is different. It is important to note that the contact spot of the threads of the housing 1 and the pinions 2 is arranged on a straight line passing through axes of the housing 1 and the pinions 2 in a plane perpendicular to the axis of the housing 1. The number of contacts of the threads of the pinions 2 and the housing 1 is determined by the length and pitch of the threads.

The contact between the two thread portions of the pinions 2 and the two thread portions of the housing 1 prevents the pinions from moving along the axis but allows the pinions 2 to roll along the thread of the housing 1 when the pinions 2 perform a planetary motion. In particular, the fact that the pinions and the housing comprise the two thread portions with opposite directions allows to balance axial forces arising when the torque is applied to the output link of the gear reducer and acting between the pinion and the housing, and further, to prevent axial movement of the pinion and to eliminate the need for structural elements, for example bearings, aimed at taking on said axial loads and preventing axial movement of the pinion and, thus, to simplify the design of the gear reducer.

In this case, the pinions 2 have cylindrical portions on both sides of the thread portions, on which bearings 3 and 4 are fixedly mounted, the bearings taking on a radial load acting on the pinions 2 and allowing the pinions 2 to rotate about their axis. The bearings 3 and 4 are mounted in openings uniformly distributed around the circumference on flanges 5 and 6. In the disclosed embodiment, the bearings 3 are needle bearings and the bearings 4 are roller bearings, but in other embodiments, the bearings can also be, for example, ball bearings. In order to reduce the length of the reducer or to increase the lengths of threads of the pinion 2 and of the housing 1, an embodiment is contemplated, in which the pinion 2 comprises an axial opening (not shown in the figure) arranged below the threads, into which bearings (not shown in the figure) similar to bearings 3 and 4 can be mounted. The bearings mounted within the axial opening of the pinion 2 can be secured on the axis fixed on flanges 5 and 6.

The radial load from bearings 3 and 4 is transferred to flanges 5 and 6. The flanges 5 and 6 are connected to each other by means of fasteners (not shown in the figure), for example screws, passed through smooth openings (not shown in the figure) in the flange 5 and screwed into threaded openings (not shown in the figure) of the flange 6, and a spacer 7 is arranged between the flanges 5 and 6, with the screws passed through the openings therein. The spacer 7 is clamped between the flanges 5 and 6. The flanges 5 and 6 are mounted rotatably around their axis in bearings 8 and 9 mounted in openings in the housing 1. Thus, the flanges 5, 6 and the spacer 7 are secured fixedly relative to each other and form the carrier of the gear reducer. It follows from the above that the pinion 2 is secured in the carrier and prevented from radial movement and maintains such position, at which the contact spot of the threads of the pinion 2 and the housing 1 is arranged at distances from the axes of the pinion 2 and the housing 1 corresponding in the same way as the number of threads starts on the pinion 2 and the housing 1.

It shall be noted that embodiments are contemplated, in which one internal thread portion is arranged on the inner surface of the housing 1 and each pinion 2 comprises one external thread portion or more than two external thread portions. It shall be noted that the number of thread portions on the housing and the pinion depends on the required torque on the output shaft, while the more thread portions are provided while the total length of threads in engagement increases, the more torque can be applied to the output link and the higher the resistance of the gear reducer to impact loads and overloads by torque at the output link. Thread portions can be separated by a groove (not shown).

In an embodiment of the gear reducer, in which the pinions 2 and the housing 1 comprise one thread portion each, bearings capable of bearing an axial load, such as radial thrust ball bearings, can be used as bearings 3 and 4 to take on the resulting axial force acting on the pinions 2 when torque is applied to the output link of the gear reducer and to prevent the pinion 2 from axial movement. If the torque that can be applied to the output link of the gear reducer is maintained at a constant value, the lengths of thread portions on the pinion 2 and the housing 1 are equal to the sum of the lengths of the two oppositely-directed thread portions on the pinion 2 and the housing 1 in the respective embodiment.

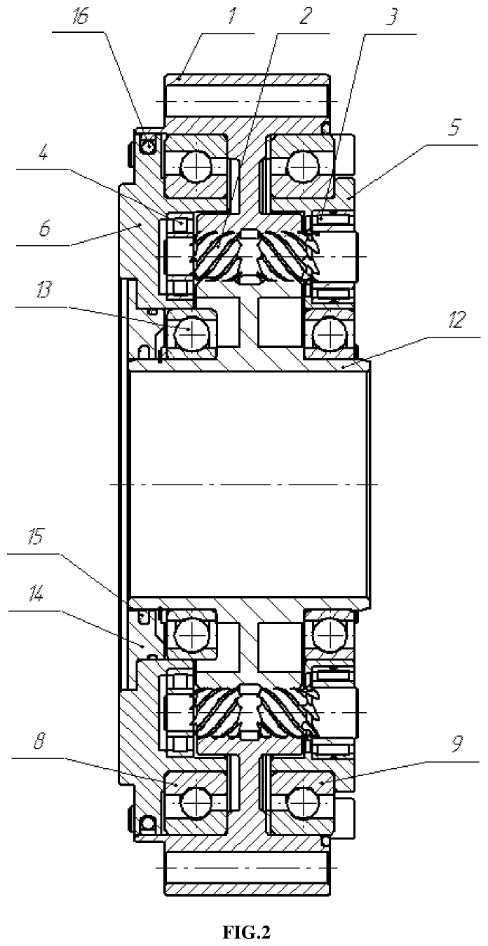

The gear reducer, in which the pinions 2 and the housing 1 comprise one thread portion each, has a shorter length compared to the gear reducer, in which the pinions 2 and the housing 1 would comprise a greater number of thread portions due to absence of grooves between the thread portions, the grooves required to provide an available space for removing the threading tool in order to avoid cutting the threads of one portion when threading the other portion with a thread of the opposite direction. Further, manufacturability is improved due to the fact that there is no need to implement portions with opposite thread directions. Furthermore, in the embodiment shown in FIG. 2, manufacturability is improved due to lack of necessity to perform the housing 1 or the sun gear 12 in assemblable form, which reduces the number of parts in the gear reducer.

It shall be noted that by preventing axial and radial movement of the pinion 2, it is possible to obtain a gear ratio of the gear reducer close to that determined by the ratio of the number of threads starts of the pinion 2 and the housing 1, taking into account manufacturing tolerances depending on the selected threading method and equipment accuracy. Further, securing the pinion 2 so that it is prevented from radial movement allows to reduce a degree of change in the gear ratio of the gear reducer as the threads wear out, since the aforementioned location of the contact spot does not change.

The profile of the side surfaces of the housing 1 threads in the disclosed embodiment is triangular. The pinions 2 in the disclosed embodiment have a convex profile of the side surfaces of the threads in the form of a circular arc. An embodiment is contemplated, in which the profile of the side surface of the housing 1 thread is in the form of a circular arc and can be convex or concave. Due to the fact that the thread of each pinion can have an increased elevation angle relative to its axis, an increase in the flow of lubricant is achieved, the flow directed along the axes of the pinions towards the pinion bearings, which reduces heating of both the pinions and the bearings, and further improves distribution of heat throughout the gear reducer and, as a result, reduces heating of the lubricant, thus reducing its degradation.

It is important to note that it is also possible to use the housing 1 as an output link when the housing 1 is fixedly secured relative to the mechanism to which the gear reducer is attached, and the carrier can be used as an output link when the housing 1 is fixedly secured relative to the mechanism.

The structure can also be implemented without a spacer 7; in this case, one of the flanges has a protrusion with a length equal to the length of the spacer 7. The bearings 8 and 9 in the disclosed embodiment are radial thrust ball bearings, but can also be, for example, conical roller bearings.

In the disclosed embodiment shown in FIG. 1, the pinions 2 comprise portions on which the gears 10 are arranged. On said portion of pinions 2, splines are arranged (not shown in the figure), and the gear 10 has an opening with matching splines. The contact between side surfaces of the splines of the pinions 2 and the gears 10 prevents them from rotating relative to each other. On the pinions 2, a collar is formed on one side and an annular groove is formed on the other side from the gear. A locking ring 11 is mounted in the groove, limiting the movement of the gear along the axis of the pinions. Other methods of fixedly securing the gear 10 to the pinions 2 can be implemented, for example, a connection using an adhesive applied to a portion of the pinions 2, on which the gear 10 is arranged. The number of pinions 2 must be a multiple of the number of teeth of the sun gear 12, but remains independent of the number of threads starts on the internal thread of the housing 1.

The sun gear 12 shaft, which in the proposed embodiment forms the input link, is mounted in two bearing supports consisting of radial ball bearings 13 mounted at least partially in the openings of flanges 5, 6 and of the spacer 7. The sun gear 12 comprises a toothed rim engaged with the gears 10. In an alternative embodiment, in order to further increase the resistance of the gear reducer to impact loads and overloads by torque at the output link, the gears 10 comprise two thread portions of opposite directions instead of toothed rims, and the sun gear 12 comprises two thread portions of opposite directions, while the engaged portions have equal elevation angles and opposite thread directions. The threaded engagement between the gears 10 and the sun gear 12 further allows using a number of pinions 2 that can be fitted into the gear reducer provided that there is a gap therebetween for providing free rotation. Said thread portions are engaged with each other. In order to balance axial forces arising when torque is applied to the output link of the gear reducer, it is possible to arrange not one but two thread portions instead of a toothed rim on the gear 10, while thread directions of the two portions are opposite, and the portions engaged with each other have an equal elevation angle and opposite thread directions. Thus, the load on the threads of the pinion 2 is reduced in the embodiment with two thread portions on the pinion 2 and the housing 1, with the load further reduced on the bearings 3 and 4, in which the pinion 2 is mounted, and in the embodiment with one thread portion on the pinion 2 and the housing 1, and therefore the resistance of the gear reducer to impact loads and overload by torque at the output link is increased.

In the flange 6, a plug 14 is installed, the plug comprising on the outer surface thereof an annular groove for a rubber ring (not shown in the figure), which fits tightly to the surface of the opening in the flange 6. On the cylindrical surface of the plug 14 opening, an annular groove is formed, in which a rubber collar 15 is mounted, the collar fitting tightly to the outer cylindrical surface of the sun gear 12 shaft and to the cylindrical surface of the groove in the plug 14 opening. On the outer surface of the flange 6, an annular groove is formed, in which a collar 16 is mounted, the collar fitting tightly to the outer cylindrical surface of the groove in the flange 6 and to the inner cylindrical surface of the opening in the housing 1. On the opposite side from the flange 6, the housing 1 can be attached to a flange (not shown in the figure) on which an electric motor (not shown in the figure) driving the sun gear 12 is arranged. In this case, seals similar to the above can be placed between housing 1 and said flange, as well as between sun gear 12 and said flange to ensure sealing of the jointings in order to prevent the lubricant from escaping from the gear reducer. The lubricant, such as engine oil, lubricates the contact surfaces of threads, toothed rims, rolling bodies of bearings, and seals. On the sun gear 12, fasteners for fastening the electric motor to the shaft can be provided, for example, formed by a flange with a plurality of openings through which fasteners can be passed, for example, formed by screws screwed into threaded openings of the flange (not shown in the figure) on the electric motor shaft. A key groove (not shown in the figure) can also be provided on the inner surface of the sun gear 12, the side surfaces of which contact the side surfaces of a key (not shown in the figure) arranged on the electric motor shaft, in order to transmit the rotation of the motor shaft to the sun gear 12.

The sun gear 12 comprises a through opening through which, for example, cables for electric motors driving subsequent manipulator links after the link, in which the gear reducer is installed, can be passed. In order to provide access to said opening at both ends thereof, the electric motor (not shown in the figure) connected to the gear reducer is provided with a hollow shaft (not shown in the figure). In another embodiment, in order to access the opening in the sun gear 12, the electric motor (not shown in the figure) can be fixedly attached from the flange 5 side to a flange (not shown in the figure) fixedly secured to the housing 1 by means of screws (not shown in the figure) so that the axis of the motor is offset from the axis of the housing 1. A toothed rim (not shown in the figure) is arranged on the sun gear 12 on the flange 5 side, the rim engaged with a gear (not shown in the figure) secured on the electric motor shaft for transferring the rotation of the electric motor shaft to the sun gear 12. The gear is fixedly secured by, for example, a key (not shown in the figure) and a screw (not shown in the figure) passed through a smooth opening (not shown in the figure) in the gear and screwed into a threaded opening (not shown in the figure) in the end face of the electric motor shaft. The toothed rim on the sun gear 12 and the gear can be replaced by engaged thread portions. Further, this implementation allows to increase the gear ratio of the gear reducer while maintaining the dimensions of the pinions 2.

The electric motor can be arranged so that the above gear on its shaft is engaged with the same toothed rim on the sun gear 12 engaged with the gears 10, as in the embodiment shown in FIG. 1. Improved manufacturability is therefore achieved by reducing the number of treated surfaces. The toothed rim on the sun gear 12 and the gear can be replaced by engaged thread portions, as in other embodiments.

An embodiment shown in FIG. 2 is contemplated, wherein the sun gear 12 comprises two thread portions of opposite directions engaged with two thread portions of the pinions 2. In this case, thread directions of each pair of said engaged portions are opposite. In order to be able to assemble such a gear reducer, the sun gear 12 or the housing 1 is divided into two coaxial parts (not shown in the figure) arranged in series and fixedly connected to each other, so as to be able to mount one of the parts of the sun gear 12 or the housing 1 after assembling one of the flanges 5 or 6 with the pinions 2 and the corresponding bearings 3 or 4 with the second part of the sun gear 12 or the housing 1. In the embodiment, in which the housing 1, the pinion 2 and the sun gear 12 each comprise one thread portion, the bearings 13 prevent axial movement of the sun gear 12 and are formed by, for example, radial thrust ball bearings.

To increase the resistance of the gear reducer to impact loads and overloads by torque at the output link, the hardness of the threads taking on the load needs to be increased. To simplify the manufacturing process of the gear reducer, the internal thread portions contacted by the thread portions of the pinions 2 can be arranged on a part separate from the housing 1 but non-rotatably connected to the housing 1 in order to subject said part to heat treatment separately from the housing 1. In this case, two internal thread portions of the opposite directions can be formed on the part in the form of a ring (not shown in the figure) which is coaxial and arranged within the housing 1 between the bearings 8 and 9. The ring comprises a flange with smooth through openings uniformly distributed around the circumference, with fasteners, for example, screws (not shown in the figure) passed through said openings and screwed into threaded openings (not shown in the figure) in the housing 1, to which the flange of the ring is pressed. An alternative embodiment involves providing a separate part in the form of a ring with two thread portions of opposite directions with splines on the outer surface (not shown in the figure), the side surfaces of which contact matching splines (not shown in the figure) in the opening of the housing 1, thus ensuring that the ring is prevented from rotating relative to the housing 1. On the sides of said ring in the housing, annular grooves (not shown in the figure) are formed with locking rings (not shown in the figure) mounted therein, limiting movement of the ring along the axis of the housing 1.

In order to reduce the play of the output link of the gear reducer relative to the input link, an embodiment is contemplated wherein the threads on the pinions 2 have an increased diameter, which leads to tension in contacts of the threads of pinions 2 and the housing 1. In this case, the initial diameters of the threads of the pinion 2 and the housing 1 are adjusted so that after increasing the diameter of the thread of the pinion 2, the contact spot of the threads of the pinion 2 and the housing 1 is located at distances from the axes of the pinions and the housing correlated in the same way as the number of threads starts of pinions 2 and the threads of the housing 1. An alternative method for reducing play in the embodiment of the gear reducer with a pinion 2 with one thread portion (not shown in the figure) is to provide two internal thread portions of the same direction and elevation angle (not shown in the figure) on the housing 1, the portions contacting the external thread portion on the pinion 2, wherein one of the internal thread portions on the housing 1 is formed as a separate part which can be secured on the housing 1 by means of, for example, a flange and screws (not shown in the figure) as described above. In this case, a compensator (not shown in the figure) is arranged between the housing 1 and said part, the length of which serves to adjust the axial position of said part relative to the housing 1. Thus, the degree of play reduction between the pinion 2 and the housing 1 is adjusted or a tension is created in the threaded engagement therebetween. Another method can include providing one thread portion on the housing 1 and two thread portions on the pinion 2, wherein the thread portions on the pinion 2 have the same thread direction and the same elevation angle, and one of the portions is formed as a separate part (not shown in the figure). In this case, a threaded connection (not shown in the figure) can be arranged between the thread portions and a compensator (not shown in the figure) is provided, the length thereof serving to adjust the axial position of one thread portion of the pinion 2 relative to the other thread portion of the pinion 2. Thus, the degree of play reduction between the pinion 2 and the housing 1 is adjusted or a tension is created in the threaded engagement therebetween.

Similar methods for eliminating play are contemplated in the alternative embodiment shown in FIG. 2, in which the pinions 2 can have an increased thread diameter leading to tension in the contacts of the threads of pinions 2 and the housing 1, as well as the pinions 2 and the sun gear 12; or the pinions 2 are comprised of two parts, and when the distance therebetween is changed by means of the compensators described above (not shown in the figure), the play between the threads of the pinion 2 and the housing 1 and between the pinion 2 and the sun gear 12 is reduced, and the play between input and output links is eliminated.

An embodiment is further contemplated, in which the housing 1 comprises more than two internal thread portions, for example three portions, wherein the thread direction of the third thread portion coincides with that of one of the two thread portions, and the pinion 2 comprises more than two thread portions, wherein the thread direction of the third thread portion coincides with that of one of the two thread portions. Each of the three thread portions of the housing 1 is engaged with a corresponding thread portion of the pinion 2, wherein the thread portions in engagement have the same elevation angle and the same thread direction. The third thread portion is formed on a separate part of the housing 1 and configured for axial movement, which allows to reduce the gap between the thread turns by bringing the two thread portions with the same thread direction together and thus reduce angular play between the pinion 2 and the housing 1 or create tension in the thread engagement therebetween. In an alternative embodiment, the third thread portion can be axially movable on the pinion 2 and prevented from axial movement on the housing 1. The third portion on the housing 1 can be formed by a separate part secured to the housing 1 by means of a flange and screws (not shown in the figure) similar to the method described above, wherein a compensator (not shown in the figure) is arranged between the housing 1 and said part, the length of which serves to adjust the axial position of said part relative to the housing 1. Thus, the degree of play reduction between the pinion 2 and the housing 1 is adjusted or a tension is created in the threaded engagement therebetween. The third thread portion can be formed separate from the other two thread portions on the pinion 2. In this case, a threaded connection (not shown in the figure) can be arranged between the thread portions and a compensator is provided, the length thereof serving to adjust the axial position of the third thread portion relative to the other two thread portions. Thus, an alternative method is provided for adjusting the degree of play reduction between the pinion 2 and the housing 1 or creating tension in the threaded engagement therebetween. Obviously, by increasing the number of thread portions on the housing 1 and the pinion 2 in the embodiment shown in FIG. 1, as well as on the housing 1, the pinion 2 and the sun gear 12 in the embodiment shown in FIG. 2, and by increasing the sum of the lengths of the thread portions on each of said gear reducer elements, an increase in the torque that can be applied to the output link of the reducer is achieved.

Another embodiment is contemplated, in which the housing 1, the pinions 2, and the sun gear 12 can simultaneously or individually consist of two parts arranged in series, coaxial with each other and fixedly secured relative to each other, each comprising one internal thread portion of the opposite direction.

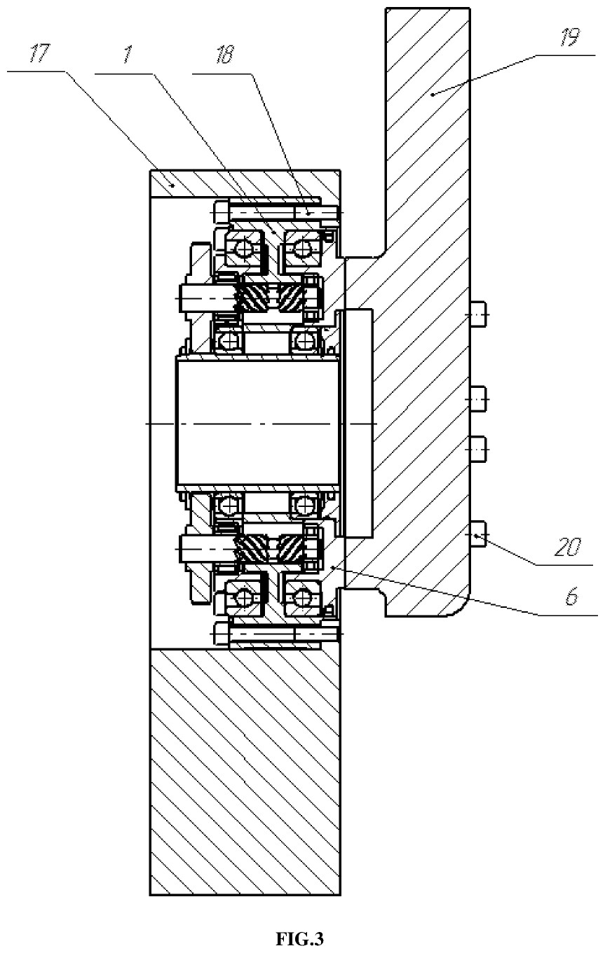

FIG. 3 shows a joint comprising the disclosed gear reducer. A first part 17 of the joint is fixedly attached to the housing 1 of the gear reducer by means of screws 18 passed through the through openings in the housing 1 and screwed into the threaded openings of the part 17 of the joint. The second part 19 of the joint is fixedly secured on the flange 6 by means of screws 20 passed through the through openings (not shown in the figure) in the part 19 of the joint and screwed into the threaded openings (not shown in the figure) of the gear reducer flange 6. Other prior art structural elements can be implemented for providing the fixed connection between the gear reducer housing 1 and the part 17 of the joint, for example by means of splines (not shown in the figure) in the opening of the part 17 of the joint and on the outer surface of the housing 1 and by means of screws 18 discussed above. In a similar manner, the part 19 of the joint can be attached to the flange 6. Therefore, one part of the joint is rotated relative to the other part of the joint, depending on whichever forms the output link of the gear reducer.

The disclosed planetary gear reducer is operated as follows. When the output link is the carrier, the housing 1 is stationary. When the sun gear 12 rotates, the gears 10 engaged therewith perform a planetary movement, rotating about their axis and the axis of the gear reducer (housing 1). The pinions 2 connected to the gears 10 rotate about their axis and roll along the internal thread portions of the housing 1, further rotating about the axis of the gear reducer and, therefore, performing a planetary movement. The pinions 2 create a circumferential force (a force directed tangentially to the circumference on which the thread contact of the pinions 2 and the housing 1 is arranged) which is transmitted through the bearings 3 and 4 to the carrier and drives the carrier in a rotary motion. A torque is thus formed between the carrier and the housing 1, and the torque and rotation speed values change between the sun gear and the carrier.

When the output link is the housing 1, the carrier is stationary. When the sun gear 12 rotates, the gears 10 engaged therewith rotate about their axis. The pinions 2 connected to the gears 10 rotate about their axis and create a circumferential force leading to rotation of the housing 1 about its axis. A torque is thus formed between carrier and the housing 1, and the torque and rotation speed values change between the sun gear and the housing.

The gear reducer shown in FIG. 2 is operated in a similar manner with the only difference being that the sun gear 12 directly contacts the pinions 2.

It is worth noting that when it is necessary to increase the torque applicable to the output link while maintaining the resistance of the gear reducer to impact loads and overloads by torque, the length of engaged thread portions can be increased while maintaining uniform loads on thread portions along their length due to the point contact between threads having a lower rigidity.

Embodiments disclosed in the present description or derived therefrom can be partly or fully combined with each other. The present invention is not limited to the particular embodiments disclosed herein in the illustrative purposes and encompasses all possible modifications and alternatives falling within the scope of the present invention defined by the claims.

1.-15. (canceled)

16. A gear reducer comprising:
a housing comprising at least one internal thread portion or being non-rotatably connected to a part comprising the at least one internal thread portion,
at least one pinion arranged in the housing, the at least one pinion being configured to move along an axis of the housing and comprising at least one external thread portion engaged with the at least one internal thread portion of the housing, wherein a rotation axis of the at least one pinion is offset from a rotation axis of the housing, wherein an elevation angle of the external thread portion is equal to an elevation angle of the internal thread portion such that a direction of the external thread portion is aligned with a direction of the internal thread portion,
a sun gear arranged in the housing and configured to drive the at least one pinion, wherein a rotation axis of the sun gear is aligned with the rotation axis of the housing,
at least one gear connected to the at least one pinion and engaged with the sun gear, and
a carrier arranged in the housing and configured to rotate relative to the housing, wherein the at least one pinion is rotatably connected to the carrier in a bearing support mounted in the carrier, wherein a rotation axis of the carrier is aligned with the rotation axis of the housing.

17. The gear reducer of claim 16, wherein the housing or the part non-rotatably connected to the housing comprises two internal thread portions, thread directions of the two internal thread portions being opposite; and the at least one pinion comprises two external thread portions, thread directions of the two external portions being opposite.

18. The gear reducer of claim 16, wherein the bearing support is configured to bear an axial load.

19. The gear reducer of claim 16, wherein the at least one pinion comprises two external thread portions, wherein the at least one pinion is connected to the at least one gear through a spline connection.

20. The gear reducer of claim 16, wherein the gear reducer comprises an electric motor comprising an electric motor shaft and a gear arranged on the electric motor shaft, and the sun gear comprises a toothed rim engaged with the gear, wherein an axis of the electric motor is offset from the axis of the housing.

21. The gear reducer of claim 16, comprising an electric motor comprising an electric motor shaft and a gear arranged on the electric motor shaft, such that the gear of the electric motor is engaged with a toothed rim on the sun gear.

22. The gear reducer of claim 16, wherein:
the housing comprises two first parts arranged coaxially in series to prevent each first part from relative movement, each first part comprising one internal thread portion, wherein a thread direction of each first part is opposite to a thread direction of the other first part.

23. The gear reducer of claim 16, wherein:
the at least one pinion comprises two second parts arranged coaxially in series to prevent each second part from relative movement, each second part comprising one external thread portion, wherein a thread direction of each second part is opposite a thread direction of the other second part.

24. The gear reducer of claim 16, wherein:
the sun gear comprises at least two external thread portions of opposite directions engaged with the at least one pinion, and the housing comprises two first parts arranged coaxially in series to prevent each of the two first parts from relative movement, each first part comprising one internal thread portion, wherein a thread direction of each first part is opposite to a thread direction of the other first part.

25. The gear reducer of claim 16, wherein:
the at least one pinion comprises two second parts arranged coaxially in series to prevent each of the two second parts from relative movement, each second part comprising one external thread portion, wherein a thread direction of each second part is opposite to a thread direction of the other second part.

26. The gear reducer of claim 16, wherein:
the sun gear comprises two third parts arranged coaxially in series to prevent each of the two third parts from relative movement, each part comprising one external thread portion, wherein a thread direction of one third part is opposite to a thread direction of the other third part.

27. The gear reducer of claim 16, wherein the sun gear is engaged with the at least one gear through thread portions of the sun gear and thread portions of the at least one gear.

28. The gear reducer of claim 16,
wherein the at least one gear comprises at least two gears, wherein the at least two gears comprise two thread portions of opposite directions, and
wherein the sun gear comprises two thread portions of opposite directions and engaged portions configured to be engaged with the at least one gear, wherein the engaged portions have equal elevation angles and opposite thread directions.

29. The gear reducer of claim 16, wherein the sun gear is mounted on a shaft with an axial opening.

30. The gear reducer of claim 16, wherein the sun gear is mounted on a hollow shaft enclosing a hollow cylinder, wherein the hollow cylinder is connected to the housing directly or through a flange.

31. A joint comprising: a gear reducer comprising:
a housing comprising at least one internal thread portion or being non-rotatably connected to a part comprising the at least one internal thread portion;
at least one pinion arranged in the housing, the at least one pinion being configured to move along an axis of the housing and comprising at least one external thread portion engaged with the at least one internal thread portion of the housing, wherein a rotation axis of the at least one pinion is offset from a rotation axis of the housing, wherein an elevation angle of the external thread portion is equal to an elevation angle of the internal thread portion such that a direction of the external thread portion is aligned with a direction of the internal thread portion;
a sun gear arranged in the housing and configured to drive the at least one pinion, wherein a rotation axis of the sun gear is aligned with the rotation axis of the housing;
at least one gear connected to the at least one pinion and engaged with the sun gear;
a carrier arranged in the housing and configured to rotate relative to the housing, wherein the at least one pinion is rotatably connected to the carrier in a bearing support mounted in the carrier, wherein a rotation axis of the carrier is aligned with the rotation axis of the housing;
a first joint portion secured on the housing to prevent the first joint portion from movement relative to the housing; and
a second joint portion secured on the carrier to prevent the second joint portion from movement relative to the carrier.
